(19) United States
(12) Patent Application Publication
(10) Pub. No.: US 2012/0115618 A1
(43) Pub. Date: May 10, 2012

(54) PARTITION MANAGEMENT IN A WAGERING GAME SYSTEM

(76) Inventors: Jorge Luis Shimabukuro, Las Vegas, NV (US); Craig J. Sylla, Round Lake, IL (US); Jun Wang, Las Vegas, NV (US)

(21) Appl. No.: 13/346,135

(22) Filed: Jan. 9, 2012

Related U.S. Application Data
(63) Continuation of application No. 12/373,187, filed on Nov. 24, 2009, now abandoned.
(60) Provisional application No. 60/806,817, filed on Jul. 10, 2006.

(51) Int. Cl. A63F 13/00

(52) U.S. Cl. 463/43

(57) ABSTRACT

A wagering game system and method of conducting a wagering game utilizing non-volatile storage configured as two or more partitions. The partitions can be restricted to store executable data and non-executable data, and the system can further include a controller operable to manage the two or more partitions.

### RELATED APPLICATION

This patent application is a continuation of U.S. patent application Ser. No. 12/373,187, filed on Nov. 24, 2009, which is a U.S. National Stage Filing under 35 U.S.C. 371 from International Patent Application Serial No. PCT/US2007/015712, filed Jul. 10, 2007, and published on Jan. 17, 2008 as WO 2008/008326 A2 and republished as WO 2008/008326 A3, which claims the priority benefit of U.S. Provisional Patent Application Ser. No. 60/806,817 filed Jul. 10, 2006 and entitled “PARTITION MANAGEMENT IN A WAGERING GAME SYSTEM”, the contents of which are incorporated herein by reference in their entireties.

### FIELD OF THE INVENTION

The invention relates generally to computerized wagering game systems, and more specifically to wagering game systems including partition management capability.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, 2007, WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. Music and environmental effects are also played through speakers in some wagering game systems to enhance or complement a theme of the wagering game. These sounds typically accompany video presentation of the wagering game on a screen, which itself often includes animation, video, and three-dimensional graphics as part of presentation of the wagering game.

The program code, multimedia information, and a variety of other information is typically stored in a nonvolatile storage device such as a hard disk drive or flash memory partition, using a file system much like that used in personal computers to store data. As more data is stored on wagering games, and the capabilities of wagering games with respect to playing multimedia, managing updates, and even changing the game presented by receiving new game code over a network are implemented, management of the data stored in nonvolatile storage becomes increasingly important.

### SUMMARY

One example embodiment of the invention comprises a computerized wagering game system including a gaming module operable to present a wagering game on which monetary value can be wagered; and a nonvolatile storage module comprising two or more partitions on at least one nonvolatile storage device and a controller operable to manage the two or more partitions.

### BRIEF DESCRIPTION OF THE FIGURES

FIG. 1 shows a computerized wagering game machine, as may be used to practice some embodiments of the invention.

FIG. 2 is a block diagram of a computerized wagering game machine as may be used to practice some embodiments of the invention.

FIG. 3 shows a more detailed example of a partition structure in a wagering game machine, consistent with an example embodiment of the invention.

FIG. 4 is a flowchart illustrating a method of managing partitions in a wagering game system, consistent with some example embodiments of the invention.

FIG. 5 is a flowchart illustrating a method of downloading and installing a downloadable wagering game using partition management, consistent with some example embodiments of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention seeks to enhance a computerized wagering game's ability to manage data stored in nonvolatile storage by providing a nonvolatile storage module comprising two or more partitions on at least one nonvolatile storage device and a controller operable to manage the two or more partitions, as well as a gaming module operable to present a wagering game on which monetary value can be wagered.

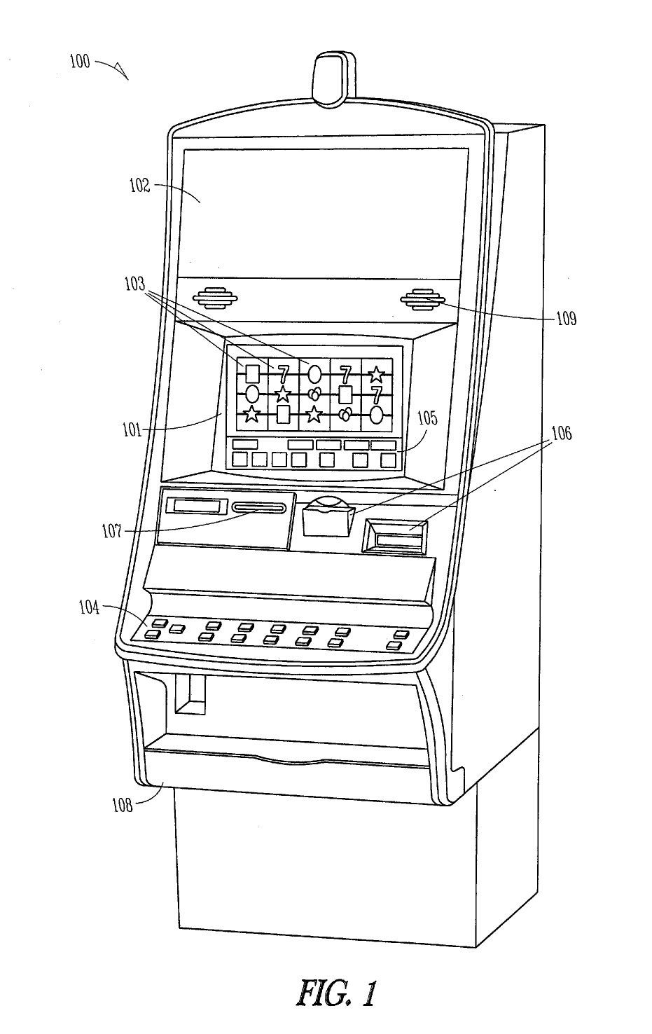

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in various embodiments a CRT display, a plasma display, an LCD display, a surface conducting electron emitter display, or any other type of display suitable for displaying electronically provided display information. In some further embodiments, additional displays such as a bonus game display or top box display 102 are further operable to display electronically provided information to a wagering game player. Alternate embodiments of the invention will have other game indicators, such as mechanical reels instead of the video graphics reels shown at 103 that comprise a part of a video slot machine wagering game.

A wagering game is implemented using software within the wagering game machine, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The game of chance implemented via the loaded software takes various forms in different wagering game machines, including such well-known wagering games as reel slots, video poker, blackjack, craps, roulette, or hold ‘em games. In some further embodiments, a secondary game or bonus game is displayed on the secondary display 102, or other information such as progressive slot information or other community game information is displayed.

The wagering game is played and controlled with inputs such as various buttons 104 or via a touchscreen overlay to video screen 101. The touchscreen is used in some embodiments to display virtual buttons, which can have unique functions in some embodiments, or can duplicate the functions provided by the mechanical buttons 104 in other embodiments. In some alternate examples, other devices such as pull arm 105 used to initiate reel spin in this reel slot machine example are employed to provide other input interfaces to the game player. The player interface components are in this example contained within or mechanically coupled to the wagering game system, but in other embodiments will be located outside the wagering game system cabinet such as by a wired or wireless electronic connection to the wagering game system.

Monetary value is typically wagered on the outcome of the games, such as with tokens, coins, bills, or cards that hold monetary value. The wagered value is conveyed to the machine such as through a changer 106 or a secure user identification module interface 107, and winnings are returned such as via a returned value ticket, a stored value card, or through the coin tray 108. Sound is also provided through speakers 109, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

In other embodiments, the computerized wagering game system takes one or more other forms, such as a mobile or portable wagering game device, a server-based wagering game device, or a networked wagering game system. These other computerized wagering game system embodiments need not contain all features of the wagering game system of FIG. 1, which does not limit the scope of a computerized wagering game but is provided as an example only.

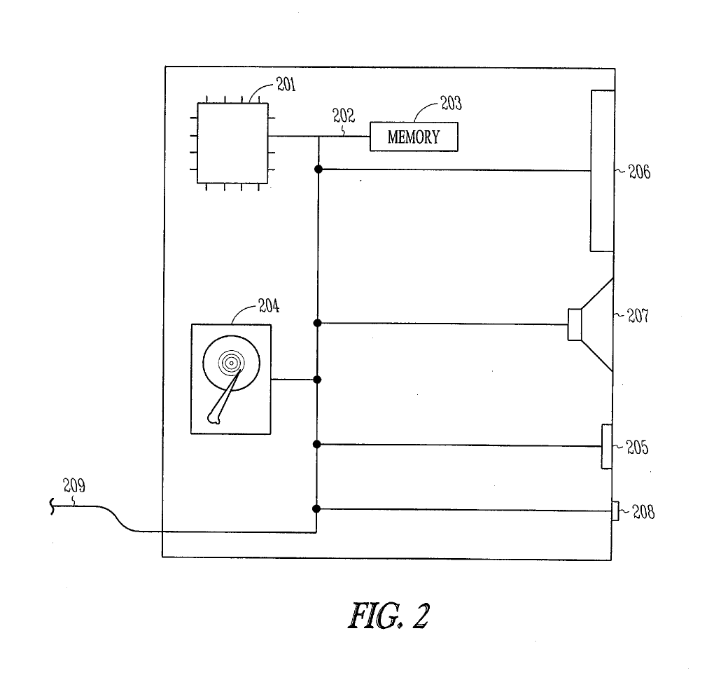

FIG. 2 shows a block diagram of an example embodiment of a wagering game system. The wagering game system includes a processor 201, which is sometimes called a microprocessor, controller, or central processing unit (CPU). In some embodiments, more than one processor is present, or different types of processors are present in the wagering game system, such as using multiple processors to run gaming code, or using dedicated processors for audio, graphics, security, or other functions. The processor is coupled via a bus 202 to various other components, including memory 203 and nonvolatile storage 204. The nonvolatile storage is able to retain the data stored therein when power is removed, and in various embodiments takes the form of a hard disk drive, nonvolatile random access memory such as a compact flash card, or network-coupled storage. Further embodiments include additional data storage technologies, such as compact disc, DVD, or HD-DVD storage in the wagering game system.

The bus 202 also couples the processor and components to various other components, such as a value acceptor 205, which is in some embodiments a token acceptor, a card reader, or a biometric or wireless player identification reader. A touchscreen display 206 and speakers 207 serve to provide an interface between the wagering game system and a wagering game player, as do various other components such as buttons 208, pullarms, and joysticks. These components are located in a wagering game machine cabinet such as that of FIG. 1 in some embodiments, but can be located in multiple enclosures comprising a wagering game system or outside a wagering game machine cabinet in other embodiments, or in alternate forms such as a wireless or mobile device.

In operation, the wagering game system loads program code from nonvolatile storage 204 into memory 203, and the processor 201 executes the program code to cause the wagering game system to perform desired functions such as to present a wagering game upon which monetary value can be wagered. This and other functions are provided by various modules in the computerized system such as an audio module, a game presentation module, or a touchscreen display module, where such modules comprise in some embodiments hardware, software, mechanical elements, manual intervention, and various combinations thereof.

The nonvolatile storage 204 is in some embodiments a hard disk drive, flash memory, or another nonvolatile storage device or group of devices separated into partitions. In one example, a single hard drive is split into three separate partitions, each of which is addressable and can be managed as though it were a separate storage device. In another example, a nonvolatile flash memory comprises a single partition and a hard disk drive comprises a single partition, and the two partitions are managed by a partition manager.

Example uses of multiple partitions include using different partitions to store operating system code, wagering game code, multimedia information, and downloaded information such as downloadable games. Further, some operating systems such as Linux can benefit from using a separate partition or separate nonvolatile storage device for virtual memory, by which a computerized wagering game machine can store “pages” of information not currently being used in memory in nonvolatile storage such as on a hard disk drive, freeing up main memory for other data. Although main memory is significantly faster than hard disk or most other nonvolatile storage, the cost for main memory is typically significantly higher than for nonvolatile storage, making memory sizes in a typical computerized wagering game system much smaller than the size of nonvolatile storage available. Many operating systems therefore use swap files, such that pages of memory can be swapped between the swap file and memory based on the need to have certain pages in memory at any given time. Using such a virtual memory scheme, the computer hardware and operating system can operate as though the wagering game system has significantly more addressable main memory than is physically installed.

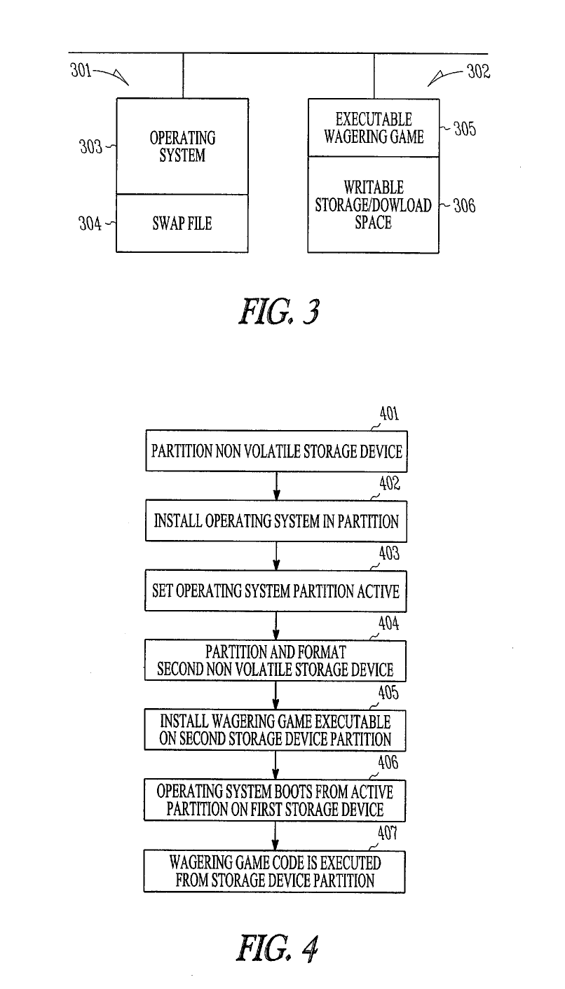

FIG. 3 shows a more detailed example of a partition structure in a wagering game machine. Although this example shows nonvolatile storage devices each having multiple partitions, other embodiments of the invention will have one or more hard disk drives or other nonvolatile storage devices having a single partition on the storage device. In this example, hard disk drives 301 and 302 are coupled to the wagering game system via the wagering game system's bus, typically through a storage device adapter such as a SCSI (Small Computer system Interface) interface card or an ATA (Advanced Technology Attachment) or SATA (Serial ATA) adapter residing between the bus and the hard disk drives. The hard disk drive 301 is partitioned into two partitions; an operating system partition 303 that contains the operating system code used to boot and run the computerized wagering game system, and a swap file partition 304 that is used to store the swap file used by the operating system's virtual memory system. Similarly, hard disk drive 302 is partitioned into an executable wagering game code space 305, and a writable storage and download space 306.

In operation, the computerized wagering game machine boots from the operating system partition 303, which uses the swap file partition 304 for the operating system's paged memory swap file. The file is given its own partition in this example in part to prevent fragmentation of the swap file, which can lead to increased read/write times and reduced virtual memory performance. Once the operating system is loaded, wagering game code is executed from hard disk drive 302's executable wagering game partition 305, to present a wagering game upon which monetary value can be wagered.

The writable storage/download partition 306 of this example is used to download and store new games, and to store other data that is not directly executed. The partition 306 is restricted such that data can be read from the partition and written to the partition, but code cannot be run from the partition. This partition is used in a further example to store downloaded game code images, and the downloaded game code is verified such as by using digital signature methods or other authentication or encryption methods before being written to the executable wagering game partition 305 for execution of the downloaded wagering game. The partition 306 is also used in some embodiments to store multimedia or other nonexecutable information, such as to store audio and video files, pictures, and other data that takes a significant amount of storage space but that is not executable and cannot affect other game or operating system code or the operation of the wagering game system.

The partitions can take various forms, including a partition designated as “active”, from which the computerized wagering game system boots, hidden partitions that aren't visible once the operating system has booted, and normal partitions that are visible but aren't designated as the boot source. Most partitions or blocks of unpartitioned space on a nonvolatile storage volume can be classified into a few major types of partition, including FAT (file allocation table) and its variants such as FAT32 that were traditionally used by DOS and earlier versions of Microsoft Windows, Linux's EXT2 and EXT3 file systems, Linux's swap file partition, NTFS (New Technology File System) as is typically used by newer versions of Microsoft Windows, unallocated space that has not been assigned to a partition, and unformatted space that belongs to a partition but that has not been formatted for data storage.

Further, partitions are traditionally identified in the Master Boot Record, or MBR of a hard disk drive or other nonvolatile storage device, which includes space to record information for up to four partitions. Because more than four partitions are sometimes desired, partitions identified as logical partitions can be created such that logical partitions aren't required to take one of the four spots in the master boot record. The four partitions identified in the master boot record can therefore be either primary or logical partitions, but because of the limitations of the master boot record, any partitions beyond four primary partitions must be logical partitions. Further, the partition identified as active must be a primary partition and not a logical partition in some embodiments for the active partition to be bootable.

Managing the partitions includes various steps such as copying, deleting, resizing, moving, merging, splitting, reformatting, defragmenting, verifying, and allocating space to a partition. Many of these operations are explained in greater detail below, as examples of how partitions in a wagering game system can be managed in various embodiments. Other examples of managing partitions include managing security of a partition, such as restricting write or read access, or limiting write or read access to certain processes such as operating system processes or other trusted processes.

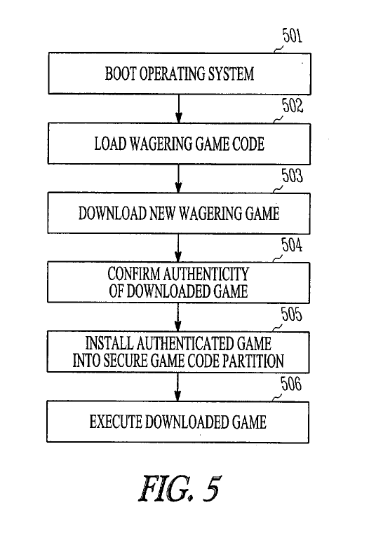

When a hard disk drive is new, it is installed in a wagering game system or other computerized system, and partitions are designated, as shown at 401 of FIG. 4. The partitioned hard disk drive can include one or more of any type of partition, such as those described above or illustrated in FIG. 3. The newly created partitions comprise in one embodiment records in the master boot record identifying what portions of the hard disk drive or other nonvolatile storage device are associated with each partition, or include other records such as extended master boot record settings, operating system records, or computer system basic input/output system settings identifying other partitions such as logical partitions.

The partition is formatted using a file system such as NTFS, FAT32, or another file system such as those described above. Once the partition has been formatted, it typically contains data structures such as file allocation tables or other records needed to store and read files in the formatted partition. Because different operating systems use different file systems, a hard disk drive formatted using one file system may not be readable by other operating systems, or drivers for the file system may be needed before the operating system can read nonvolatile storage formatted using other file systems.

In this example, the disk drives are formatted using the Linux operating system, which uses the EXT3 file system for data partitions such as 303 and the Linux Swap file system for the Linux swap file partition 304. The operating system is installed at 402 in partition 303, which is a primary partition. The partition 303 is then set active at 403, which identifies the partition as the partition that will be used to boot the computerized wagering game system. A second hard disk drive is partitioned and formatted at 404, and the executable wagering game is installed into partition 305 at 405.

When the wagering game is in operation, it boots its operating system at 406 from active partition 303, and the operating system uses the Linux swap partition 304 to store a paged memory swap file. The wagering game presentation code, such as the code necessary to conduct, account, and display a wagering game is loaded from partition 305 and executed at 407.

To ensure the security of a wagering game system, the partitions are subject to various security restrictions in some embodiments. In one example, the operating system partition is verified by the basic input output system (BIOS), preboot execution environment (PXE) boot extension, or other mechanism, such as by comparing the hash value of the operating system to a known valid hash value, or by comparing a digital signature of the operating system or a digital signature of a hash of the operating system to a known valid digital signature. In one more detailed example, a hash value of the operating system partition is digitally signed and provided to the wagering game system, which can verify the digital signature and hash value.

The operating system similarly examines the executable wagering game code for a digital signature, verifying that the wagering game code is authentic and has not been tampered with such as by using a digitally signed hash of the wagering game code partition. The operating system partition 303 and the executable wagering game code partition 305 are write protected, such that the contents of the partitions cannot be written other than by authorized applications or operating system processes.

This enables secure download and installation of new wagering games in some embodiments, using a “scratch” or writable storage partition such as 306 of FIG. 3. An example of such a system is shown in the flowchart of FIG. 5, and described below.

At 501, the wagering game system boots, and the basic input output system (BIOS), preboot execution environment (PXE) boot extension, trusted platform module, or other trusted information stored in the wagering game system is used to verify the integrity of the boot volume, such as active operating system volume 303. In some embodiments, one or more other volumes such as wagering game executable volume 305 are also verified such as by checking a digital signature of a hash value derived from the hard drive contents. In this example, the content of swap file partition 304 is erased before or during the operating system boot to ensure that the swap file volume doesn't contain any content other than the swap file written by the operating system. Security of the swap file partition is managed by the operating system, which doesn't allow writes to the volume except for operating system writes to the swap file.

Verification of the integrity and authenticity of the operating system partition, and of other partitions or information, relies in some embodiments on encryption technology such as digital signatures or certificates. Encryption technologies typically utilize a symmetric or asymmetric algorithm, designed to obscure the data such that a specific key is needed to read or alter the data. A symmetric algorithm relies on agreement of a secret key before encryption, and the decryption key is either the same as or can be derived from the encryption key. Secrecy of the key or keys is vital to ensuring secrecy of the data in such systems, and the key must be securely distributed to the receivers before decryption such as via a secure key exchange protocol. Common symmetric algorithms include DES, 3DES or triple-DES, AES, Blowfish, Twofish, IDEA, RD2, RC4, and RC5.

Public key algorithms, or asymmetric algorithms, are designed so that the decryption key is different than and not easily derivable from the encryption key. The term “public key” is used because the encryption key can be made public without compromising the security of data encrypted with the encryption key. Anyone can therefore use the public key to encrypt a message, but only a receiver with the corresponding decryption key can decrypt the encoded data. The encryption key is often called the public key, and the decryption key is often called the private key in such systems. Such systems can be used to digitally sign a document where the signer uses the secret private key to encrypt the document or some portion of it such as a one-way hash of the document, and then publishes the encrypted message. Anyone can use the signer's published or known public key to decrypt the signed message, confirming that it was encrypted or signed by the owner of the public/private key pair. In some examples, the publisher of a wagering game executable, an operating system, or other partition contents digitally signs the contents of the partition such that the partition can be verified by decrypting the partition or a signed hash of the partition with a known and trusted public key. Common public key algorithms include RSA, Diffie-Hellman, and ElGamal.

One-way hash functions take an input string and derive a fixed length hash value. The hash value is typically of significantly shorter length than the document, and is often calculated by application of some type of data compression algorithm. The functions are designed so that it is extremely difficult to produce an input string that produces a certain hash value, resulting in a function that is considered one-way. Data can therefore be checked for authenticity by verifying that the hash value resulting from a given one-way hash function is what is expected, making authentication of data relatively certain. Hash functions can be combined with other methods of encryption or addition of secret strings of text in the input string to ensure that only the intended parties can encrypt or verify data using the one-way hash functions. Common examples of one-way hash function encryption include MD2, MDC2, MD4, MD5, and SHA.

A variation on one-way hash functions is use of Message Authentication Codes, or MAC. A MAC comprises a one-way hash function that further includes a secret key, such that knowledge of the key is necessary to encode or verify a given set of data. MACs are particularly useful where the hash value would otherwise be subject to unauthorized alteration or replacement, such as when transmitted over a public network or a network that would be difficult to protect, such as a very large network linking hundreds of computerized wagering game machines in a large gaming facility.

Encryption can be used in its various forms to obscure the content of a message for transmission over a wagering game network, so that a third party is not so easily able to monitor network traffic and read or alter messages sent over the network such as alteration of a downloadable game. The ability of various wagering game systems to communicate with one another securely relies in many embodiments on the secure distribution or storage of keys, such as distributing asymmetric keys such as public keys in a manner such that the identity of the public key owners can be firmly established. This is achieved in some embodiments by establishing chain of trust from one trusted system to another, so that once a single system is declared to be authentic and trustworthy, it can “vouch” for other systems such as by authenticating their public keys, user-unique identifiers, asymmetric keys, or other such data.

Such methods of key management are often handled via a trusted third party known as a Certificate Authority, which is a service provider that signs certificates carrying public keys and identification information as a means of authenticating the data contained in the certificate to other parties. The certificate authority is typically a party well-known and trusted to all involved, and in some environments such as Internet web pages is preconfigured as a trusted authority in web browsers before distribution. Various embodiments of the present invention use certificate authorities, trusted platform modules, securely stored or unalterable trusted public key data, or other technologies as a basis of trust.

Returning to FIG. 5, the operating system is authenticated before loading at 501 such as by verifying a digital signature of a hash value of the partition, and the wagering game code stored in the wagering game executable partition is similarly authenticated and loaded at 502. The wagering game executable partition is not writable in this example, except for by certain authorized processes or programs under the direction of the operating system. Downloaded games or other written data is written to the “scratch” writable partition 306 of FIG. 3, which is able to store data but from which executable code cannot be run.

One process authorized to write to the executable wagering game partition 305 enables authentication, installation, and execution of downloadable games. In this example, a wagering game player, wagering game system administrator, or other agent causes a wagering game to be downloaded such as via a network connection to a central wagering game server into the writable storage partition 306. The downloaded wagering game is in one embodiment a file, such as a compressed .zip, .tar, lzh, or other compressed file, along with a digital signature of a hash value of the compressed file, such as a message authentication code. The digital signature and hash value are compared against a known and trusted public key and a calculated hash value of the downloaded compressed file, to ensure authenticity of the downloaded game content at 504.

Once the downloaded game has been authenticated, it is installed in the executable wagering game partition 305 so that it can be executed at 506. In some embodiments, the writable storage partition 306 cannot be written during the authentication process, to ensure that the file being authenticated is not altered while it is being authenticated and installed. In other embodiments, the downloaded wagering game data is loaded into a protected area of memory and is written from memory after authentication, ensuring the security of the authenticated data.

Although the storage devices shown here are local to various wagering game machines, the storage devices need not be local to any particular element or system. In various alternate embodiments, the storage elements comprise various types of local and remote storage, including network attached storage (NAS), remote or local iSCSI, wirelessly coupled storage, ethernet attached storage, storage area networks (SANs), and other such storage configurations.

These examples show how management of multiple partitions, including creation and configuration of partitions as well as management of security and access to partitions in a wagering game machine can be used to provide a more efficient and more secure wagering game system. Partitions are managed in some embodiments by a nonvolatile storage controller, which comprises hardware, software, and various combinations thereof in various embodiments. Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

1. A computer-implemented method of authenticating gaming data in a gaming system having one or more processors and at least one non-volatile memory device, the method comprising:
storing, to a non-executable partition of the at least one non-volatile memory device, gaming data and authentication data for use in authenticating the gaming data;
verifying that the gaming data is authentic by comparing the authentication data with trusted authentication information using a game verification module executed by the one or more processors;
installing the authenticated gaming data, via the game verification module, to an executable partition of the at least one non-volatile memory device; and
executing the authenticated gaming data on the gaming system from the executable partition of the non-volatile memory.

2. The method of claim 1, further comprising:
preventing writing to the non-executable partition during verifying.

3. The method of claim 1, further comprising:
copying the gaming data to protected memory before verifying the gaming data; and
installing the authenticated gaming data from the protected memory after verifying.

4. The method of claim 1, wherein the non-executable partition and the executable partition comprise a single memory device.

5. The method of claim 1, wherein the non-executable partition and the executable partition comprise separate memory devices.

6. The method of claim 1, wherein the trusted authentication information is provided by a certificate authority.

7. The method of claim 1, wherein the trusted authentication information comprises at least one of a digital signature, a symmetric algorithm, an asymmetric algorithm, a hash function, and a message authentication code (MAC).

8. The method of claim 1, wherein the gaming data includes at least one wagering game.

9. The method of claim 8, wherein the at least one wagering game is downloaded from a central wagering game server to the at least one non-volatile memory device via a communications network.

10. The method of claim 9, wherein one of a wagering game player and a wagering game system administrator causes the downloading of the at least one wagering game.

11. A computerized wagering game system comprising:
one or more processors; and
one or more memory storage devices including instructions that, when executed by the one or more processors, cause the one or more processors to operate with the one or more memory devices to:
store to a non-executable partition of the one or more memory devices, gaming data and authentication data for use in authenticating the gaming data;
verify that the gaming data is authentic by comparing the authentication data with trusted authentication information;
in response to the gaming data being authentic, install the gaming data to an executable partition of the one or more memory devices and execute the gaming data from the executable partition.

12. The wagering game system of claim 11, wherein the one or more processors operate with the one or more memory devices to prevent writing to the non-executable partition during verifying.

13. The wagering game system of claim 11, wherein the one or more processors operate with the one or more memory devices to:
copy the gaming data to protected memory before verifying the gaming data; and
install the authenticated gaming data from the protected memory after verifying.

14. The wagering game system of claim 11, wherein the non-executable partition and the executable partition comprise a single memory device of the one or more memory devices.

15. The wagering game system of claim 11, wherein the non-executable partition and the executable partition comprise separate memory devices of the one or more memory devices.

16. The wagering game system of claim 11, wherein the trusted authentication information is provided by a certificate authority.

17. The wagering game system of claim 11, wherein the one or more memory devices comprises one of a hard drive, a compact disc storage device, a DVD storage device, and an HD-DVD storage device.

18. A computer-readable, non-transitory medium storing executable instructions for causing a gaming system including at least one non-volatile memory device to perform the method comprising:
storing, to a non-executable partition of the at least one non-volatile memory device, gaming data and authentication data for use in authenticating the gaming data;
verifying that the gaming data is authentic by comparing the authentication data with trusted authentication information using a game verification module executed by the one or more processors;
installing the authenticated gaming data, via the game verification module, to an executable partition of the at least one non-volatile memory device; and
executing the authenticated gaming data on the gaming system from the executable partition of the non-volatile memory device.

19. The computer-readable medium of claim 18, the method further comprising:
preventing writing to the non-executable partition during verifying.

20. The computer-readable medium of claim 18, the method further comprising:
copying the gaming data to protected memory before verifying the gaming data; and
installing the authenticated gaming data from the protected memory after verifying.

21. The computer-readable medium of claim 18, wherein the non-executable partition and the executable partition comprise a single memory device.

22. The computer-readable medium of claim 18, wherein the non-executable partition and the executable partition comprise separate memory devices.

23. The computer-readable medium of claim 18, wherein the trusted authentication information is provided by a certificate authority.

24. The computer-readable medium of claim 18, wherein the trusted authentication information comprises at least one of a digital signature, a symmetric algorithm, an asymmetric algorithm, a hash function, and a message authentication code (MAC).

25. The computer-readable medium of claim 18, wherein the gaming data includes at least one wagering game.

26. The computer-readable medium of claim 25, wherein the at least one wagering game is downloaded from a central wagering game server to the at least one non-volatile memory device via a communications network.

27. The computer-readable medium of claim 26, wherein one of a wagering game player and a wagering game system administrator causes the downloading of the at least one wagering game.
